(19) United States
(12) Patent Application Publication
(10) Pub. No.: US 2016/0059654 A1
(43) Pub. Date: Mar. 3, 2016

(54) LEAF SPRING TYPE SUSPENSION

(71) Applicant: TOYOTA JIDOSHA KABUSHIKI KAISHA, Toyota-shi (JP)

(72) Inventor: Minoru TAKAYAMA, Miyoshi-shi (JP)

(21) Appl. No.: 14/824,503

(22) Filed: Aug. 12, 2015

(30) Foreign Application Priority Data
Aug. 26, 2014 (JP) 2014-171485

(51) Int. Cl. B60G 11/113; F16F 1/26; F16F 9/54; B60G 13/00

(52) U.S. Cl. CPC B60G 11/113; B60G 13/003; F16F 1/26; F16F 9/54

(57) ABSTRACT

Objective:

The strength of a U bolt sheet 60 is raised while suppressing a weight rise and a cost rise.

Means for Solution:

A connecting pin 71 which connects a lower connecting portion 22 of a shock absorber 20 therewith is formed in a U bolt sheet 60. This connecting pin 71 is formed so that its axis Lpin passed between axes La and Lb of bolt portions 51a and 51b of a U bolt 50. Thereby, the lower connecting portion 22 of the shock absorber 20 can be supported with a doubly-supported-beam structure of the U bolt sheet 60 which uses the bolt portions 51a and 51b as fixed ends.

### BACKGROUND OF THE INVENTION

1. Field of the Invention

The present invention relates to a leaf spring type suspension in which an axle housing is fixed to a leaf spring with a U bolt.

2. Description of the Related Art

Generally, a leaf spring type suspension is constituted so that an axle housing is supported with two right and left leaf springs extending in a front-and-rear direction of a vehicle body, and it combines a function as a suspension spring and a function as a positioning device of the axle housing. A leaf spring is integrally formed by fixing two or more leaves in piles with a center bolt and further bundling them with a clip band. The front end of the leaf spring is connected with a spring bracket formed in a vehicle body frame, and the posterior end of the leaf spring is connected with a shackle formed in the vehicle body frame.

The axle housing is fixed with the U bolt at a middle position in a longitudinal direction of the leaf spring. Such a fixation structure of an axle housing and a leaf spring is disclosed in the patent document 1 (PTL1), for example.

FIG. 7 and FIG. 8 are drawings for showing a fixation structure of a leaf spring 110 and an axle housing 130 in a conventional device. U bolts 150 are disposed on both sides of the leaf spring 110 in a width direction of a vehicle body so as to respectively straddle from the above the axle housing 130 in a front-and-rear direction of a vehicle body, and their ends are inserted into bolt insertion holes 161 of a U bolt sheet 160 arranged on a lower side of the leaf spring 110 and are tightened with nuts 155. Thereby, with the U bolts 150 and U bolt sheet 160, the axle housing 130 and the leaf spring 110 are compressed in an up-and-down direction, and the axle housing 130 is fixed to the leaf spring 110. In the drawing, the sign 113 shows a center bolt, the sign 190 shows a bracket, the sign 167 shows a center bolt interference evasion hole, and the sign 168 shows a reinforcement metal member. The bracket 190 is interposed between the upper surface of the leaf spring 110 and the axle housing 130.

The leaf spring type suspension comprises a shock absorber 120. As for the shock absorber 120, its upper connecting portion 121 is connected with a vehicle body frame B, and its lower connecting portion 122 is connected with the U bolt sheet 160. A connecting pin 171 protruding toward a width direction of the vehicle is formed in the U bolt sheet 160, which connects a lower connecting portion 122 of the shock absorber 120 therewith. The U bolt sheet 160 has an extended portion 100 extended ahead rather than the location connected with the U bolts 150, and the connecting pin 171 is formed in this extended portion 100. In addition, although a configuration in which the shock absorber 120 is arranged to slant upward and posteriorly is also known, in case of such a configuration, the U bolt sheet 160 has an extended portion 100 extended backward rather than the connecting part with the U bolts 150, and the connecting pin 171 is formed in this extended portion 100.

### CITATION LIST

### Patent Literature

[Patent Document 1] Japanese Patent Application Laid-Open (kokai) No. 2003-172387

### SUMMARY OF THE INVENTION

For the U bolt sheet 160, it is required not to be broken by load repeatedly inputted from the shock absorber 120 or not to be deformed to have the nut 155 loosen. In the above-mentioned leaf spring type suspension, since the shock absorber 120 is connected ahead rather than the U bolts 150 in the vehicle body as shown in FIG. 9, it has a cantilever beam structure to load F inputted from the shock absorber 120. That is, in this structure, among the parallel bolt portions 151a and 151b which constitute the U bolts 150, the bolt portion 151a on the front side is used as a fixed end A, and the portion outside the fixed end A (region surrounded with the thick dashed line in FIG. 8) receives the load F inputted from the shock absorber 120.

Therefore, in the U bolt sheet 160, only a part outside rather than (on the front side of the vehicle body from) the fixed end A serves as a part which functions as a strength against the load F inputted from the shock absorber 120. For this reason, in order to meet the demand on a strength, it is necessary to take the measure, such as to enlarge the basic cross section of the U bolt sheet 160 or to change the material of the U bolt sheet 160 into a high stress material. However, such a measure will cause a weight rise and a cost rise.

The present invention has been made in order to cope with the above-mentioned problems, and its objective is to raise the strength of a U bolt sheet (strength over the load inputted from a shock absorber), while suppressing a weight rise and a cost rise.

In order to attain the above-mentioned objective, a feature of the present invention is in that;

a leaf spring type suspension which comprises a leaf spring (10) supporting an axle housing (30) and a shock absorber (20) attenuating a relative motion between a vehicle body (B) and said axle housing, and

U bolts (50) are respectively disposed on both sides of said leaf spring in a width direction of the vehicle body at a location where said leaf spring and said axle housing intersect in a planar view so as to straddle said axle housing in a front-and-rear direction of the vehicle body, and the ends of two parallel bolt portions (51a, 51b) which each U bolt (50) has are inserted into bolt insertion holes (61) of a U bolt sheet and nuts (55) are screwed at said ends and thereby said axle housing and said leaf spring are compressed with a pair of said U bolts and said U bolt sheet, and said axle housing is fixed to said leaf spring, wherein:

an upper end (21) of said shock absorber is connected with the vehicle body and an lower end (22) thereof is connected with said U bolt sheet, and

said U bolt sheet is connected with said shock absorber through a connecting shaft extending from said U bolt sheet in a width direction of the vehicle body, and an axis (Lpin) of said connecting shaft (71) passes between the axes (La, Lb) of said two bolt portions which each of said pair of said U bolts has.

The leaf spring type suspension according to the present invention comprises the leaf spring and the shock absorber. For example, the leaf spring is integrally formed by piling two or more leaves (blade spring), it is arranged in a front-and-rear direction of the vehicle body and its front and rear ends are connected with the vehicle body, and it supports the axle housing in the central portion in the front-and-rear direction of the vehicle body. Therefore, the leaf spring is arranged so as to intersect with the axle housing at an approximately right angle in a planar view.

The leaf spring type suspension fixes the axle housing to the leaf spring by compressing the axle housing and the leaf spring with the U bolts and the U bolt sheet. In this case, the U bolts are respectively disposed on both sides of the leaf spring in the width direction so as to straddle the axle housing in the front-and-rear direction of the vehicle body, and the ends of two parallel bolt portions which each U bolt has are inserted into the bolt insertion holes of the U bolt sheet and nuts are screwed at the ends. For example, the axle housing is arranged at the upper surface side of the leaf spring, and the U bolt sheet is arranged at the lower surface side of the leaf spring. In this status, a pair of the U bolts are arranged so as to straddle the axle housing from the above in the front-and-rear direction of the vehicle body, and the nuts are tightened on the lower surface side of the U bolt sheet.

The upper end of the shock absorber is connected with the vehicle body and the lower end thereof is connected with the U bolt sheet. It is configured so that the U bolt sheet is connected with the shock absorber through the connecting shaft extending from the U bolt sheet in the width direction of the vehicle body, and the axis of the connecting shaft passes between the axes of the two bolt portions which each of the pair of the U bolts has.

Therefore, the lower end of the shock absorber can be supported with a doubly-supported-beam structure of the U bolt sheet using as fixed ends the front and rear bolt portions which each U bolt has. Thereby, the load which is inputted from the shock absorber can be received by effectively using the cross section between the bolt portions of the U bolt sheet. Moreover, as compared with a conventional cantilever beam structure, a bending moment which acts on the U bolt sheet decreases. As a result, the strength of the U bolt sheet (strength over the load inputted from the shock absorber) can be raised, while suppressing a weight rise and a cost rise.

In addition, in the above-mentioned explanation, in order to help understanding of the present invention, the signs used in the embodiments are attached in parenthesis to the configurations of the present invention corresponding to the embodiments. However, each of the constituent requirements of the present invention is not limited to the embodiments specified with the above-mentioned signs.

### BRIEF DESCRIPTION OF THE DRAWINGS

FIG. 1 is a lateral view for showing the fixation structure of an axle housing and the connection structure of a shock absorber in a leaf spring type suspension according to the present embodiment.

FIG. 2 is (a) a top view and (b) a lateral view for showing a U bolt sheet.

FIG. 3 is a perspective view of a U bolt sheet.

FIG. 4 is a perspective view of a bracket.

FIG. 5 is a diagram for explaining a doubly-supported-beam structure which supports a shock absorber.

FIG. 6 is a diagram for explaining the region of a U bolt sheet, which receives the load inputted from a shock absorber.

FIG. 7 is a lateral view for showing the fixation structure of an axle housing and the connection structure of a shock absorber in a conventional leaf spring type suspension.

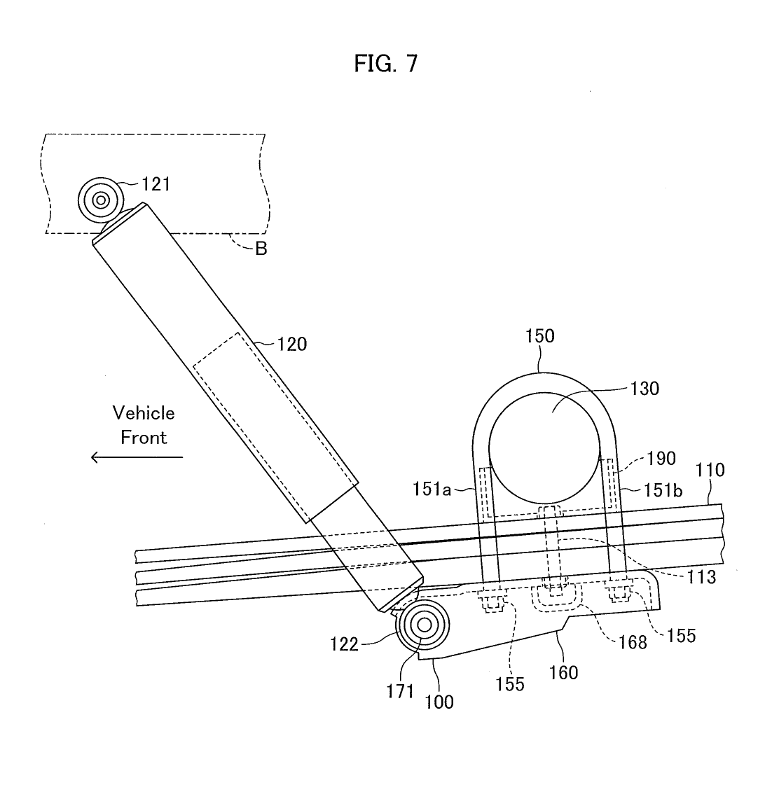

FIG. 8 is (a) a top view and (b) a lateral view for showing a U bolt sheet used for the conventional leaf spring type suspension.

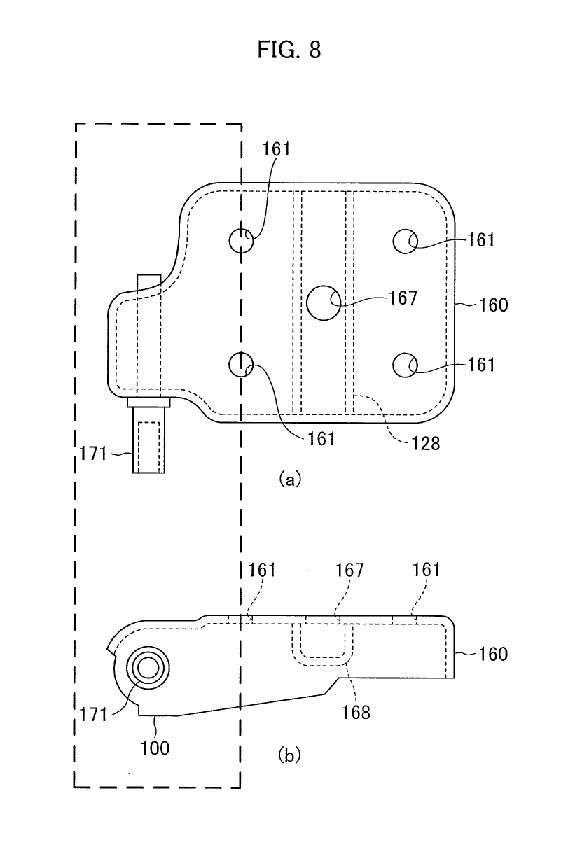

FIG. 9 is a diagram for explaining a cantilever beam structure which supports a shock absorber in the conventional leaf spring type suspension.

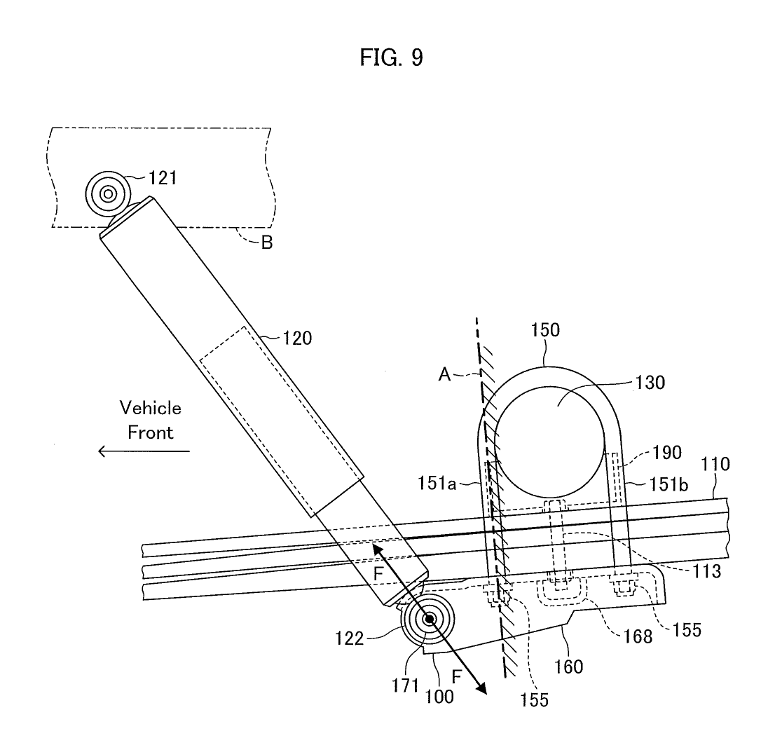

### DESCRIPTION OF THE INVENTION

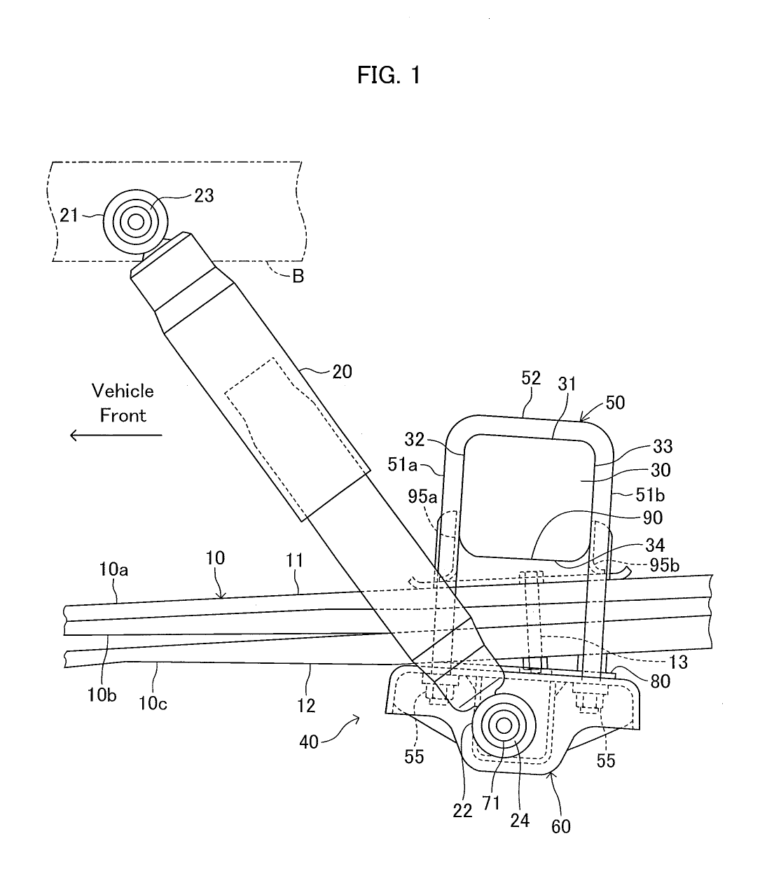

Hereafter, a leaf spring type suspension according to one embodiment of the present invention will be explained using drawings. FIG. 1 is a lateral view for showing the connection structure of an axle housing and the fixation structure of a shock absorber in the leaf spring type suspension. The leaf spring type suspension comprises a leaf spring 10 extending approximately in a front-and-rear direction of a vehicle body, a shock absorber 20, and a fixation apparatus 40 which fixes an axle housing 30 to the leaf spring 10. This leaf spring type suspension is a suspension which hangs from the vehicle body a rigid axle which connected right and left rear-wheels of the vehicle with one axle shaft on both right and left sides. In the present embodiment, only the structure of one side of the right and left rear-wheels will be explained, and the explanation about the structure of the other side of the rear-wheels will be omitted. FIG. 1 is a view for showing the fixation structure of the axle housing 30 and the connection structure of the shock absorber 20 on the side of the left rear wheel.

The leaf spring 10 has a plurality of leaves (blade spring) 10a, 10b and 10c. Although the leaf spring 10 has the three leaves 10a, 10b and 10c in this embodiment, the number of leaves may be any. The leaves 10a, 10b and 10c are piled, connected and fixed with a center bolt 13 at a middle position in its longitudinal direction, and bundled with a clip band, not shown, to be integrally formed.

Between the mutually facing plate surfaces of each of the leaves 10a, 10b and 10c, a pad (not shown) is disposed suitably, and the abrasion by the friction between plate surfaces and creaking sound are reduced with this pad. The spring eye (not shown) is formed in the both ends in the longitudinal direction of the leaf (main leaf) 10a arranged in the uppermost location, respectively. One side (front end) of the spring eyes is connected with a spring bracket (not shown) formed in the vehicle body frame B, and the other side (posterior end) is connected with a shackle (not shown) formed in the vehicle body frame B. About the leaf spring 10, since it is the same as that in a conventional device, explanation beyond this is omitted.

The axle housing 30 is fixed and supported on the upper surface 11 of this leaf spring 10. The leaf spring 10 intersects with the axle housing 30 approximately at right angle in a planar view, since it is disposed so that its longitudinal direction is mostly directed in the front-and-rear direction of the vehicle body (it does not need to be completely consistent with the front-and-rear direction of the vehicle body). Although the axle housing 30 in the present embodiment formed in a shape of a square pipe with four rounded corners, it may be a circular-cylinder type as shown in the conventional device.

The fixation apparatus 40 is used in a fixation of the axle housing 30. The fixation apparatus 40 comprises the two U bolts 50, U bolt sheet 60, and bracket 90. In addition, since the two U bolts 50 are disposed on both sides of the leaf spring 110 in the width direction of the vehicle body to be opposed to each other, although the U bolt 50 on the inner side in the width direction of the vehicle body is not displayed behind the U bolt 50 on the outer side in the width direction of the vehicle body, they both have the same configuration.

The U bolt 50 is integrally formed from the two bolt portions 51a and 51b and the connecting portion 52 which connects the bolt portions 51a and 51b in the shape of a U character so that they are parallel mutually. The male screw (not shown) is formed at the end of each of the bolt portions 51a and 51b. The two bolt portions 51a and 51b and the connecting part 52 do not necessarily have a boundary, and they are formed continuously. The U bolt 50 is formed so that the shape on its inner circumference side is consistent with the outer periphery (an upper surface 31, a front surface 32 and a rear surface 33) of the axle housing 30. Hereafter, the bolt portions 51a and 51b will be simply referred to as a “bolt portion 51” when it is not necessary to distinguish them.

The axle housing 30 is mounted on the upper surface 11 of the leaf spring 10 in a status that the bracket 90 is interposed between them. In this status, the two U bolts 50 are respectively disposed on both sides of the leaf spring 110 in the width direction of the vehicle body so as to straddle the axle housing 30 from the above in the front-and-rear direction of the vehicle body. That is, each U bolt 50 is arranged so that one bolt portion 51a contacts with the front face 32 of the axle housing 30, the other bolt portion 51b contacts with the rear surface 33, and the connecting portion 52 contacts with the upper surface 31 of the axle housing 30.

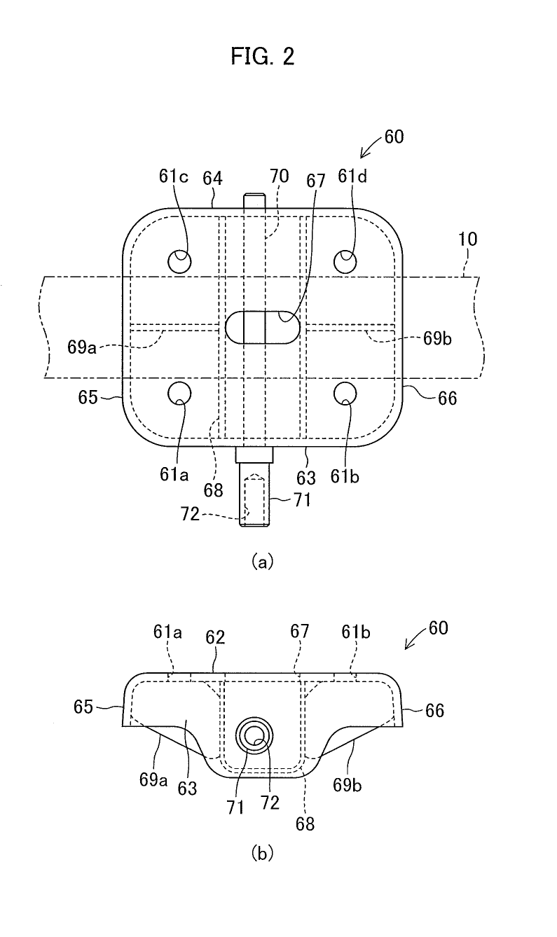

The U bolt 50 is disposed so that the end of the bolt portion 51 projects below rather than the lower surface 12 of the leaf spring 10. The U bolt sheet 60 is disposed on the lower surface 12 of the leaf spring 10. As shown in FIG. 2 (a), four bolt insertion holes 61a, 61b, 61c and 61d are formed in the U bolt sheet 60. Among these, the bolt insertion holes 61a and 61b are insertion holes for the U bolt 50 formed on the outer side in the width direction of the vehicle body, and the bolt insertion holes 61c and 61d are insertion holes for the U bolt 50 formed on the inner side in the width direction of the vehicle body (not shown, hidden, in the drawing). Hereafter, the four bolt insertion holes 61a, 61b, 61c and 61d will be referred to as the bolt insertion hole 61, when it is not necessary to distinguish them.

The nuts 55 are screwed at the ends of the bolt portion 51 of each U bolt 50, in a status that the ends have been inserted into the bolt insertion holes 61 formed in U bolt sheet 60. By tightening the nuts 55, the axle housing 30 and the leaf spring 10 are compressed in the up-and-down direction by the U bolts 50 and U bolt sheet 60, and the axle housing 30 is fixed to the leaf spring 10.

Hereafter, each member of the fixation apparatus 40 will be explained. As shown in FIG. 2, the U bolt sheet 60 is formed to be in a square box-like shape with no bottom and its four corners and respective sides rounded. Hereafter, in the U bolt sheet 60, a portion which forms an upper surface will be referred to as an upper plate portion 62, a portion which forms a side surface facing outward in the width direction of the vehicle body will be referred to as an outside plate portion 63, a portion which forms a side surface facing inward in the width direction of the vehicle body will be referred to as an inside plate portion 64, a portion which forms a side surface facing to the front of the vehicle body will be referred to as a front side plate portion 65, and a portion which forms a side surface facing to the rear of the vehicle body will be referred to as a rear side plate portion 66.

In the upper plate portion 62, as mentioned above, the bolt insertion holes 61a, 61b, 61c and 61d into which the bolt portion 51 of the U bolt 50 is inserted are drilled in the four corners, and an interference evasion hole 67 for avoiding an interference with the center bolt 13 at the center is drilled. The outside plate portion 63 and the inside plate portion 64 are in a shape identical to each other and extend downward so that its dimension in the up-and-down direction becomes large at the center.

A U-shaped reinforcement metal member 68 with its cross-section in a shape of U character is formed at the center of the back side of the U bolt sheet 60 towards the width direction of the vehicle body. The edge face of the U-shaped reinforcement metal member 68 is welded to the upper plate portion 62, the outside plate portion 63 and the inside plate portion 64 of the U bolt sheet 60. Moreover, the reinforcing plates 69a and 69b directed in the front-and-rear direction of the vehicle body, respectively, are formed on the both sides of the U-shaped reinforcement metal member 68. The edge face of the reinforcing plate 69a on the front side of the vehicle body is welded to the upper plate portion 62, the front side plate portion 65 and the U-shaped reinforcement metal member 68. The edge face of the reinforcing plate 69b on the rear side of the vehicle body is welded to the upper plate portion 62, the rear side plate portion 66 and the U-shaped reinforcement metal member 68.

The pin 70 for connecting the shock absorber 20 is disposed so as to penetrate the outside plate portion 63 and the inside plate portion 64 approximately horizontally in the width direction of the vehicle body. The pin 70 is arranged in a region which is at the middle position in U bolt sheet in the front-and-rear direction of the vehicle body 60 and is a region surrounded by the U-shaped reinforcement metal member 68 in three directions. The pin 70 is a circular-cylinder object and projects longwise toward the outside in the width direction of the vehicle body from the outside plate portion 63, and this portion projecting from the outside plate portion 63 outward in the width direction of the vehicle body becomes a portion to be connected with the lower connecting portion 22 of the shock absorber 20. Hereafter, the portion projecting from the outside plate portion 63 outward in the width direction of the vehicle body will be especially referred to as the connecting pin 71. A female screw 72 is formed inside the connecting pin 71.

As shown in FIG. 2, the penetration location of the pin 70 is set up so that the pin 70 passes between the bolt insertion holes 61 into which the U bolt portion 51 of each U bolt 50 is inserted, namely, between the bolt insertion hole 61a and the bolt insertion holes 61b and between the bolt insertion hole 61c and the bolt insertion hole 61d, in a planar view.

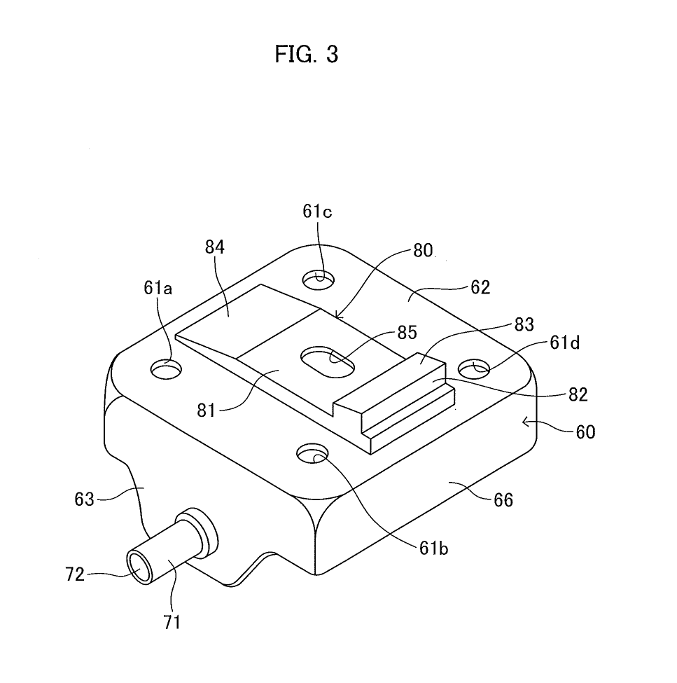

In the present embodiment, the orientation of the upper surface 31 of the axle housing 30 and the orientation of the lower surface 12 of the leaf spring 10 are not parallel in the location where the axle housing 30 is fixed to the leaf spring 10. Therefore, if the U bolt sheet 60 is directly contacted with the lower surface 12 of the leaf spring 10, the bolt portion 51 of the U bolt 50 cannot be made to intersect with the upper plate portion 62 of the U bolt sheet 60 at right angle. That is, it comes to that the bolt portion 51 penetrates aslant the upper plate portion 62 of the U bolt sheet 60 and cannot be properly tightened with the nut 55. Then, as shown in FIG. 3, between the U bolt sheet 60 and the leaf spring 10, an angle adjustment metal member 80 called a caster wedge intervenes. The angle adjustment metal member 80 is welded to the upper surface of the upper plate portion 62 of the U bolt sheet 60.

The angle adjustment metal member 80 is integrally formed by a substrate portion 81 and a support base portion 82 erected upward on the rear side of the vehicle body in the substrate portion 81. The bottom surface of the substrate portion 81 is tightly welded to the upper surface of the upper plate portion 62 of the U bolt sheet 60. A slope 83 which is acclivitous toward the rear side of the vehicle body to the bottom surface of the substrate portion 81 is formed in the support base portion 82.

Moreover, a slope 84 is formed also on the front side of the vehicle body in the substrate portion 81. These two slopes 83 and 84 are portions which contact by face with the lower surface 12 of the leaf spring 10, and they are formed so as to be located on the same flat surface. The angular difference (tilt angle) between the upper surface of the U bolt sheet 60 and the lower surface 12 of the leaf spring 10 can be arbitrarily set by adjustment of the angles of gradient of the two slopes 83 and 84. Moreover, an interference evasion hole 85 which faces the interference evasion hole 67 formed in the U bolt sheet 60 is formed in the center of the substrate portion 81.

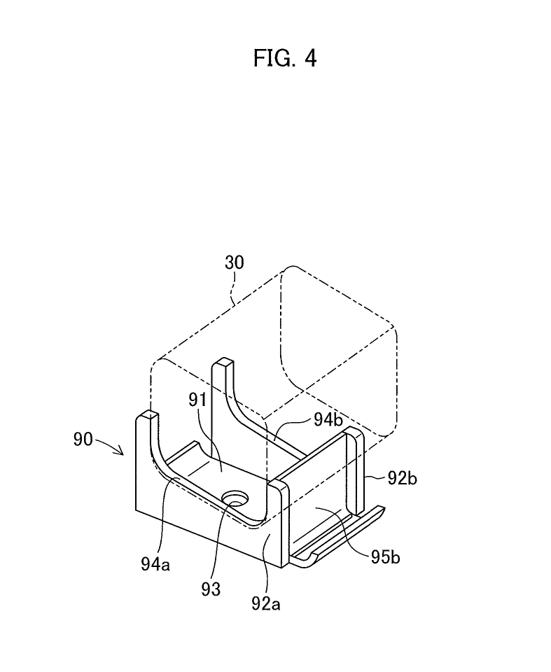

The bracket 90 is interposed between the leaf spring 10 and the axle housing 30. The bracket 90 is integrally formed by the substrate portion 91 which contacts with the upper surface 11 of the leaf spring 10 and the supporting wall portions 92a and 92b which are erected upward from both sides of the substrate portion 91 in the width direction of the vehicle body and face mutually, as shown in FIG. 4. In the center of the substrate 91, an interference evasion hole 93 for avoiding an interference with the center bolt 13 is drilled.

The supporting wall portions 92a and 92b are mutually in the same shape and have notches consistent with the outer periphery (a lower surface 34, a front surface 32 and a rear surface 33) of the axle housing 30, and the axle housing 30 is inserted in the notches 94a and 94. Therefore, the notches 94a and 94b are formed in a shape which maintains the angle-of-gradient difference between the lower surface 34 of the axle housing 30 and the upper surface 11 of the leaf spring 10.

Moreover, in the bracket 90, the support plates 95a and 95b which support the side surfaces (the front surface 32 and rear surface 33) of the axle housing 30 are formed in the front-and-rear direction of the vehicle body. Each of the support plates 95a and 95b is welded and fixed on the internal surface of the bracket 90. In addition, in FIG. 4, only the support plate 95b on the rear side of the vehicle body is indicated, and the support plate 95a on the front side of the vehicle body is omitted.

As mentioned above, the axle housing 30 is mounted on the upper surface 11 of the leaf spring 10 through the bracket 90. On the axle housing 30, the two U bolts 50 are disposed on both sides in the width direction of the vehicle body so as to straddle the axle housing 30 from the above in the front-and-rear direction of the vehicle body. On the lower surface 12 of the leaf spring 10, the U bolt sheet 60 is arranged through the angle adjustment metal member 80. In this status, the ends of the bolt portion 51 of each U bolt 50 are inserted into the bolt insertion hole 61 formed in the U bolt sheet 60, and the nut 55 is screwed at the bolt portion 51. In this way, the axle housing 30 and the leaf spring 10 are compressed in the up-and-down direction, and the axle housing 30 is fixed to the leaf spring 10. In this case, the axle housing 30 is stably supported by the two supporting wall portions 92a and 92b of the bracket 90.

The shock absorber 20 is a shock absorber in a shape of a circular-cylinder, the upper connecting part 21 formed in the upper end is connected with the vehicle body frame B, the lower connecting portion 22 formed in the lower end is connected with the U bolt sheet 60, and the relative motion (vertical vibration) of the vehicle body frame B and the axle housing 30 is attenuated. As the shock absorber 20, a common twin tube type shock absorber etc. can be used, for example.

The upper connecting portion 21 and the lower connecting portion 22 are formed cylindrical, respectively. The upper connecting portion 21 has a cylindrical bush 23 disposed inside, and is connected with an absorber bracket (not shown) fixed to the vehicle body frame B through this bush 23. Moreover, also in the lower connecting portion 22, a cylindrical bush 24 is erected inside.

The lower connecting portion 22 is connected with the U bolt sheet 60 by making the connecting pin 71 projecting from the U bolt sheet 60 penetrate a through-hole of the bush 24 and screwing a bolt (not shown) into the female screw 72 formed inside the connecting pin 71, in a status that a retainer in a shape of a ring plate, which is not shown, on both sides of the bush 24 in its axial direction.

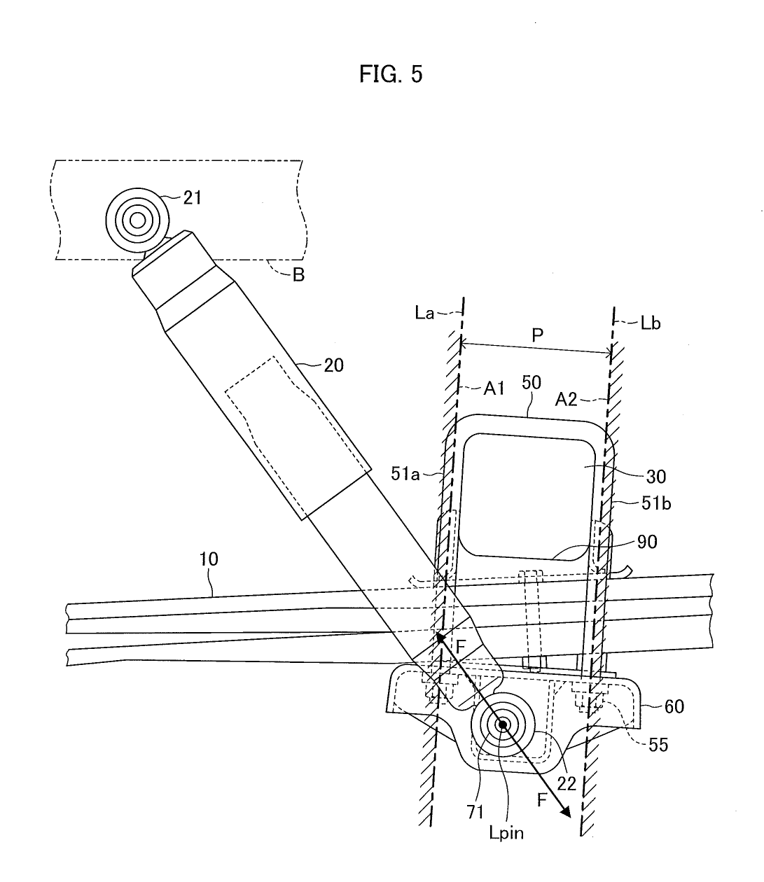

In this connection structure of the shock absorber 20 and the U bolt sheet 60, as shown in FIG. 5, the connecting location is set up so that the axis Lpin of the connecting pin 71 passes between the axes La and Lb of the bolt portions 51a and 51b of each U bolt 50. Therefore, the lower connecting portion 22 of the shock absorber 20 can be supported with the doubly-supported-beam structure of the U bolt sheet 60 using as fixed ends A1 and A2 the bolt portions 51a and 51b being apart at a predetermined distance P in the front-and-rear direction of the vehicle body.

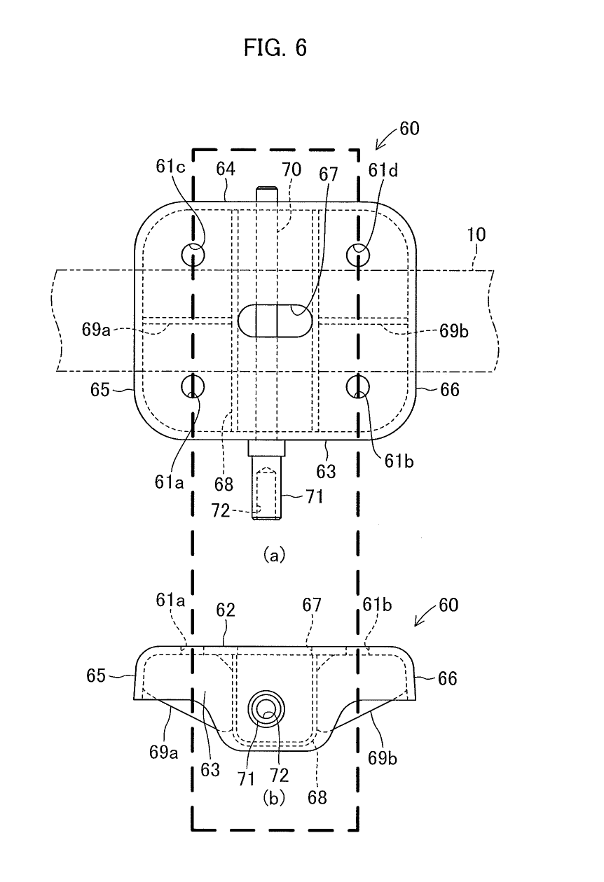

Thereby, the load which is inputted from the shock absorber 20 can be received by effectively using the cross section between the bolt portions 51a and 51b of the U bolt sheet 60 (region denoted by a bolt pitch P in FIG. 5, region surrounded with the thick dashed line in FIG. 6). Moreover, as compared with a conventional cantilever beam structure, a bending moment which acts on the U bolt sheet 60 becomes about one fourth (¼). Moreover, the U bolt sheet 60 can be made compact. As a result, in accordance with the present embodiment, the strength of the U bolt sheet 60 (strength over the load inputted from the shock absorber 20) can be improved, while suppressing a weight rise and a cost rise.

Moreover, since the cross section of the U bolt sheet 60 is effectively used and the bending moment which acts on the U bolt sheet 60 becomes about one fourth (¼), the deformation of the U bolt sheet 60 is prevented and its rigidity can be improved. Thereby, since the shock absorber 20 can be connected stably, the original performance of the shock absorber 20 can be maintained. Therefore, excellent handling stability and ride quality can be secured for a long term while maintaining a cheap structure of the bushes 23 and 24 of the shock absorber 20.

In addition, in the present embodiment, the mass of the U bolt sheet 60 could be reduced about 20% compared with a conventional device. Moreover, the rigidity of the U bolt sheet 60 could be increased about 5 times compared with a conventional device.

Although the embodiment according to the leaf spring type suspension of the present invention has been explained as mentioned above, the present invention is not limited to the above-mentioned embodiment, and various modifications are possible for the present invention unless it deviates from the objective of the present invention.

For instance, although the shock absorber 20 is connected at the outside location of the leaf spring 10 in the width direction of the vehicle body in the present embodiment, the shock absorber 20 may be connected at the inside location of the leaf spring 10 in the width direction of the vehicle body. Moreover, the shock absorber 20 may be arranged to slant upward and posteriorly. Moreover, the orientations in which the shock absorber 20 is arranged may be different between a right wheel and a rear wheel (for instance, the shock absorber 20 may be arranged to slant upward and anteriorly on one of wheels, while the shock absorber 20 may be arranged to slant upward and posteriorly on the other of the wheels).

Moreover, in the present embodiment, although the axle housing 30 is arranged at the upper surface 11 side of the leaf spring 10 and the U bolt sheet 60 is arranged at the lower surface 12 side thereof, the arrangement may be upside down. That is, the U bolt sheet 60 may be arranged at the upper surface 11 side of the leaf spring 10 and the axle housing 30 may be arranged at the lower surface 12 side thereof, and the U bolt 50 may straddle the axle housing 30 from the bottom.

What is claimed is:

1. A leaf spring type suspension which comprises a leaf spring supporting an axle housing and a shock absorber attenuating a relative motion between a vehicle body and said axle housing, and
U bolts are respectively disposed on both sides of said leaf spring in a width direction of the vehicle body at a location where said leaf spring and said axle housing intersect in a planar view so as to straddle said axle housing in a front-and-rear direction of the vehicle body, and the ends of two parallel bolt portions which each U bolt has are inserted into bolt insertion holes of a U bolt sheet and nuts are screwed at said ends and thereby said axle housing and said leaf spring are compressed with a pair of said U bolts and said U bolt sheet, and said axle housing is fixed to said leaf spring, wherein:
an upper end of said shock absorber is connected with the vehicle body and an lower end thereof is connected with said U bolt sheet, and
said U bolt sheet is connected with said shock absorber through a connecting shaft extending from said U bolt sheet in a width direction of the vehicle body, and the axis of said connecting shaft passes between the axes of said two bolt portions which each of said pair of said U bolts has.
